(19) United States
(12) Patent Application Publication
(10) Pub. No.: US 2009/0106757 A1
(43) Pub. Date: Apr. 23, 2009

(54) WORKFLOW SYSTEM, INFORMATION PROCESSING APPARATUS, DATA APPROVAL METHOD, AND PROGRAM

(75) Inventor: Kensuke Kawajiri, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/254,438

(22) Filed: Oct. 20, 2008

(30) Foreign Application Priority Data
Oct. 23, 2007 (JP) 2007-275321

(51) Int. Cl. G06F 9/46

(52) U.S. Cl. 718/100

(57) ABSTRACT

An electronic approval system which is capable of improving reliability of approval in a workflow. The electronic approval system comprises a server and a plurality of multifunction peripherals (MFPs). The server manages a status of data to be handled in the workflow. An MFP performs a visual output of the data to be handled in the workflow, and transmits configuration information containing output configuration for the visual output of the data by the MFP and/or information for identifying the MFP, to the server. The server manages approval permitting conditions as information indicative of conditions for making the data approvable, in association with the workflow, and determines whether or not to manage the data as approvable, based on the configuration information transmitted from the MFP and the approval permitting conditions.

### BACKGROUND OF THE INVENTION

1. Field of the Invention

The present invention relates to a workflow system (an electronic approval system) which enables a user to check the validity of expression of an intention for approval by another user on the system, using a computer or an image forming apparatus, an electronic approval method, and a storage medium storing a program for implementing the electronic approval method.

2. Description of the Related Art

In recent years, a so-called electronic approval system has been gradually coming into widespread use which makes it possible not only to share information between users, but also to electronically execute a sequence of works in which an approver examines an electronically generated document, performs approval processing, and transmits the approved document to a distribution destination, using a network.

Simultaneous transmission of a generated document to specific people can be achieved by E-mail. However, it is beyond the capability of E-mail software to sequentially transmit a generated electronic document to predetermined people such that upon completion of processing on the electronic document by one user, the document is automatically transmitted to a next user, while enabling monitoring where the document has reached and measuring of time taken for each step.

In view of this, new workflow software has appeared so as to attain the above-mentioned capability. For example, workflow software for a proposed plan document approval system is well known (see e.g. Japanese Patent Laid-Open Publication No. H06-348738). This workflow software realizes a system in which a creator fills out predetermined items on a predetermined company-specific proposed plan document form using a personal computer, to prepare a proposed plan document, and then the prepared document is circulated to seniors in the company so as to be sequentially approved by them, followed by returning to the creator. In this system, when a defect is found in the document during the process for approval, the document is returned to the creator without being approved, so that the creator can correct the document and then set the corrected document on an route for circulation thereof for approval again.

However, in the workflow, there is a possibility that approval processing cannot be performed correctly by an approver. As an example, a case can be considered in which while the creator expects an approver to check the image quality or hue of data created by the creator, the approver prints out the data in black and white for check, and approves the printed data. In this case, since the approver checks a monochrome printout, it is impossible to check hue or the like, and hence the check cannot be performed correctly. However, the workflow system regards the approval by the approver as proper. As described above, the conventional workflow system is imperfect in reliability of approval.

### SUMMARY OF THE INVENTION

The present invention provides an electronic approval system and an electronic approval method which are capable of improving reliability of approval, and a storage medium storing a program for implementing the electronic approval method.

In a first aspect of the present invention, there is provided a workflow system for executing a workflow including a step of approving data, comprising a server apparatus, and an image output apparatus, wherein the server apparatus comprises a management unit adapted to manage a status of data to be handled in the workflow, wherein the image output apparatus comprises an output unit adapted to perform a visual output of the data to be handled in the workflow, and a transmission unit adapted to transmit configuration information containing output configuration for the visual output of the data by the output unit and/or information for identifying the image output apparatus, to the server apparatus, and wherein the management unit manages approval permitting conditions as information indicative of conditions for making the data approvable, in association with the workflow, and determines whether or not to manage the data as approvable, based on the configuration information transmitted from the transmission unit of the image output apparatus and the approval permitting conditions.

In a second aspect of the present invention, there is provided an information processing apparatus for managing a workflow including a step of approving data, comprising a management unit adapted to manage a status of data to be handled in the workflow, a storage unit adapted to store approval permitting conditions as information indicative of conditions for making the data approvable, in association with the workflow, a reception unit adapted to receive configuration information containing output configuration for a visual output of the data by an external image output apparatus and/or information for identifying the image output apparatus, and a determination unit adapted to determine whether or not to manage the data as approvable, based on the configuration information received by the reception unit and the approval permitting conditions stored in the storage unit.

In a third aspect of the present invention, there is provided a data approval method for a workflow system that includes a server apparatus, and an image output apparatus, and carries out a workflow including a step of approving data, wherein the server apparatus manages a status of data to be handled in the workflow, wherein the image output apparatus performs a visual output of the data to be handled in the workflow, wherein the image output apparatus transmits configuration information containing output configuration for the visual output of the data and/or information for identifying the image output apparatus, to the server apparatus, and wherein the server apparatus manages approval permitting conditions as information indicative of conditions for making the data approvable, in association with the workflow, and determines whether or not to manage the data as approvable, based on the configuration information transmitted from the image output apparatus and the approval permitting conditions.

In a fourth aspect of the present invention, there is provided a data approval method for an information processing apparatus for managing a workflow including a step of approving data, comprising managing a status of data to be handled in the workflow, storing in a storage unit approval permitting conditions as information indicative of conditions for making the data approvable, in association with the workflow, receiving configuration information containing output configuration for a visual output of the data by an external image output apparatus and/or information for identifying the image output apparatus, and determining whether or not to manage the data as approvable, based on the received configuration information and the approval permitting conditions stored in the storage unit.

In a fifth aspect of the present invention, there is provided a storage medium storing a program for causing a computer to execute a data approval method for an information processing apparatus for managing a workflow including a step of approving data, wherein the data approval method comprises managing a status of data to be handled in the workflow, storing in a storage unit approval permitting conditions as information indicative of conditions for making the data approvable, in association with the workflow, receiving configuration information containing output configuration for a visual output of the data by an external image output apparatus and/or information for identifying the image output apparatus, and determining whether or not to manage the data as approvable, based on the received configuration information and the approval permitting conditions stored in the storage unit.

According to the present invention, it is possible to prevent an approver from performing unreliable approval e.g. by approving a registered document without required examination, to thereby improve reliability of approval.

The features and advantages of the invention will become more apparent from the following detailed description taken in conjunction with the accompanying drawings.

### BRIEF DESCRIPTION OF THE DRAWINGS

FIG. 1 is a diagram of the configuration of an electronic approval system (workflow system) according to a first embodiment of the present invention.

FIG. 2 is a block diagram of an MFP appearing in FIG. 1.

FIG. 3 is a block diagram of a client or a server appearing in FIG. 1.

FIG. 4 is a diagram useful in explaining a workflow process carried out using the electronic approval system in FIG. 1.

FIG. 5 is a diagram showing an example of document management information stored in the server in FIG. 3 on a document-by-document basis.

FIG. 6 is a diagram useful in explaining to an approval process carried out in a case where a user prints a registered document using the MFP in FIG. 2 to checks the printed document, and then notifies the server of approval of the registered document using the client.

FIG. 7 is a diagram showing in detail examples of user information, device information, and device configuration information to be sent to the server from the MFP in the approval process in FIG. 6.

FIG. 8 is a diagram showing in detail an example of an approval permitting condition stored in the server on a workflow-by-workflow basis in the approval process in FIG. 6.

FIG. 9 is a view of an example of a creation screen for creating the approval permitting condition in FIG. 8.

FIG. 10 is a diagram useful in explaining a process carried out for preparing the approval permitting condition in FIG. 8.

FIG. 11 is a flowchart of a process carried out by the MFP in the approval process in FIG. 6.

FIG. 12 is a flowchart of a document status changing process carried out by the server in the approval process in FIG. 6.

FIG. 13 is a flowchart of an approval request acceptance process carried out by the server in the approval process in FIG. 6.

FIG. 14 is a flowchart of a process carried out by the client in the approval process in FIG. 6.

FIG. 15 is a diagram useful in explaining an embedding process carried out by an electronic approval system (workflow system) according to a second embodiment of the present invention in a case where when a user prints a registered document, the MFP in FIG. 2 embeds user information, device information, and device configuration information in the registered document.

FIG. 16 is a diagram useful in explaining an approval process carried out in a case where the user prints the registered document using the MFP for use in approval to check the printed document, and notifies the server appearing in FIG. 1 of approval of the document using the MFP.

FIG. 17 is a flowchart of a process carried out by the MFP in the approval process in FIG. 16.

FIG. 18 is a flowchart of a process carried out by the server in the approval process in FIG. 16.

FIG. 19 is a diagram useful in explaining an approval process carried out by an electronic approval system (workflow system) according to a third embodiment of the present invention in a case where a user displays a registered document using the client in FIG. 3 to check the displayed document, and then notifies the server of approval of the document using the client.

FIG. 20 is a diagram showing in detail examples of user information, device information, and device configuration information to be sent to the server from the MFP in the approval process in FIG. 19.

FIG. 21 is a diagram showing in detail an example of approval permitting conditions stored in the server on a workflow-by-workflow basis in the approval process in FIG. 19.

FIG. 22 is a flowchart of a process carried out by the client in the approval process in FIG. 19.

FIG. 23 is a flowchart of a document status changing process carried out by the server in the approval process in FIG. 19.

FIG. 24 is a flowchart of an approval request acceptance process carried out by the server in the approval process in FIG. 19.

### DETAILED DESCRIPTION OF THE EMBODIMENTS

The present invention will now be described in detail below with reference to the accompanying drawings showing embodiments thereof.

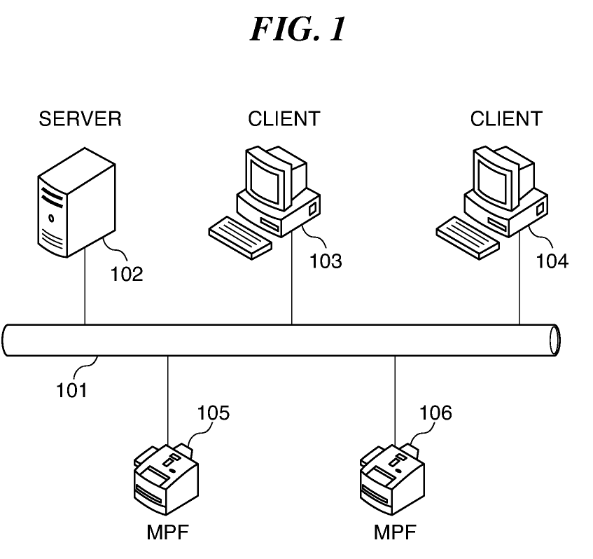

FIG. 1 is a diagram of the configuration of an electronic approval system (workflow system) according to a first embodiment of the present invention.

This electronic approval (data approval) system is realized by a server/client system. The electronic approval system manages a workflow up to approval of document data by an approver. Then, the electronic approval system checks validity of the approval of the document data. Document data managed in the workflow by the electronic approval system includes image data, data created by a document creation application, etc. Hereafter, a piece of document data may be sometimes simply referred to as a “document”.

Connected to a network (LAN) 101 is a server 102 as an example of an information processing apparatus for managing the workflow and database. Further, a plurality of client computers (client PCs) 103 and 104 are connected to the network 101 so as to perform various operations including an approval operation for approval of a certain action. Furthermore, a plurality of MFPs (Multifunction Peripherals) 105 and 106 are connected to the network 101 so as to perform various kinds of operations including an approval operation for approval of a certain action and print out various kinds of documents. Each of the MFPs 105 and 106 is an example of an image output apparatus.

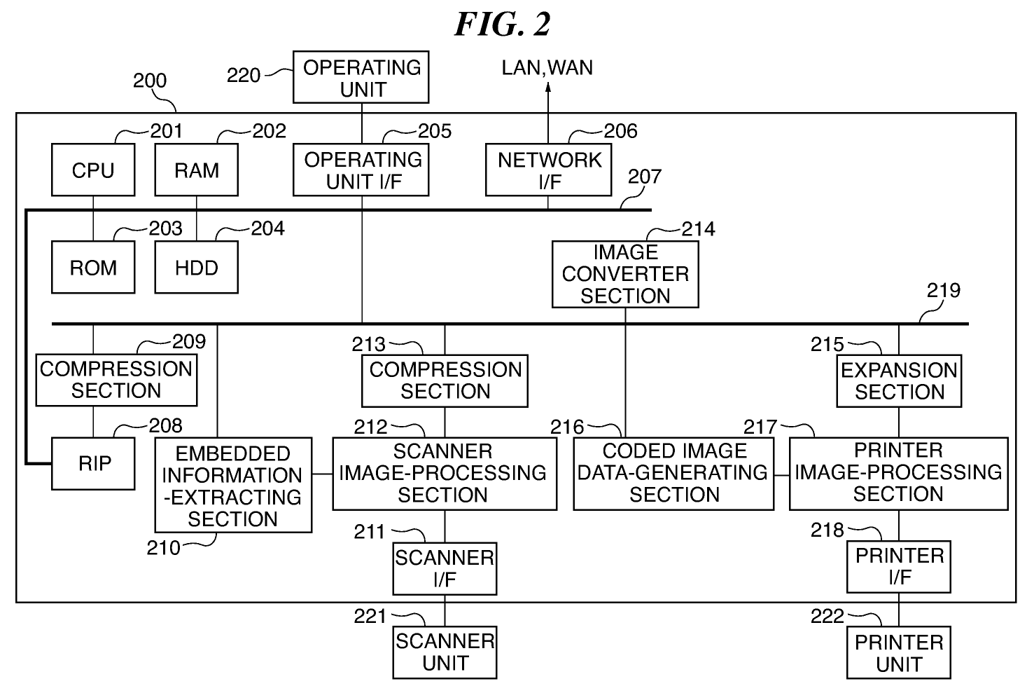

FIG. 2 is a block diagram of the hardware configuration of an MFP appearing in FIG. 1.

Referring to FIG. 2, the MFP 105 (106) is comprised of a controller 200, an operating section 220, a scanner section 221, and a printer section 222. In the controller 200, a CPU 201 performs centralized control of the overall operation of the MFP as well as various kinds of processing to be carried out within the controller 200, based on control programs and the like stored in a ROM 203.

A RAM 202 serves not only as a system work memory for operation of the CPU 201, but also as a memory for temporarily storing image data. The ROM 203 stores a boot program and the like for the apparatus. An HDD (hard disk drive) 204 is capable of storing system software and image data.

An operating section interface 205 provides interface for connection between a system bus 207 and the operating section 220. The operating section interface 205 receives image data to be displayed on the operating section 220 via the system bus 207, and outputs the received image data to the operating section 220. Further, the operating section interface 205 outputs information input from the operating section 220 to the system bus 207.

A network interface 206 is connected to a LAN, a WAN (the network 101 appearing in FIG. 1) and the system bus 207 to input and output information. An image bus 219 serves as a transmission path for transmitting and receiving image data.

A scanner image-processing section 212 corrects, processes, and edits image data received from the scanner section 221 via a scanner interface 211. An embedded information-extracting section 210 detects a pattern embedded in a background image of image data, or extracts additional information from image data. Processing carried out by the embedded information-extracting section 210 will be described in detail hereinafter.

A compression section 213 receives image data and compresses the same. An expansion section 215 expands data, and then converts the expanded data into raster image data to deliver the same to a printer image-processing section 217.

The printer image-processing section 217 receives image data delivered from the expansion section 215, and performs image processing on the image data while referring to attribute data added to the image data. Further, the printer image-processing section 217 synthesizes the image data with coded image data generated by a coded image data-generating section 216, when instructed to do so. The image data processed by the printer image-processing section 217 is transferred to the printer section 222 and is output visually as a printout through image forming operation in the printer section 222.

The coded image data-generating section 216 generates coded image data, such as a two-dimensional barcode (QR code) image, a barcode image, and an image generated by an information embedding technique. Images are formed using information read by the CPU 201 via a memory card slot, not shown, or input via the operating section 220.

It should be noted that coded images are generated by executing programs stored in the HDD 204 or the ROM 203. Image data subjected to image processing is output to the printer section 222 via a printer interface 218.

An image converter section 214 performs predetermined conversion processing, such as image rotation, color space conversion, binary/multivalue conversion, image superimposing, and thinning-out, on image data.

A RIP 208 receives intermediate data generated based on PDL code data, and generates bitmap data (multivalue data). The generated bitmap data is compressed by a compression section 209 and is delivered to the image bus 219.

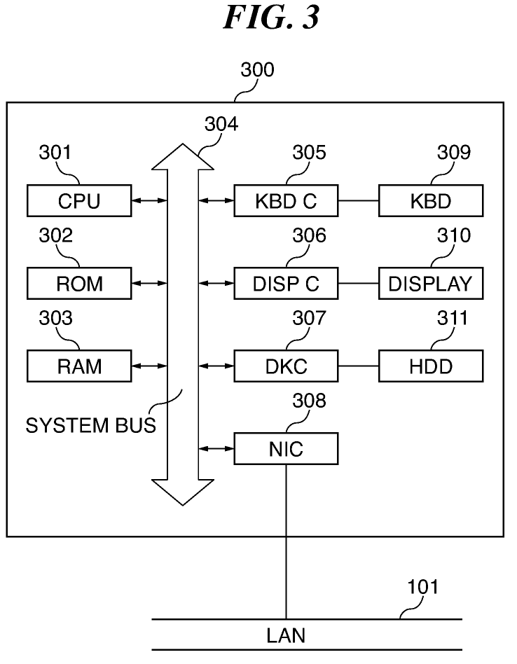

FIG. 3 is a block diagram of the hardware configuration of the client or the server appearing in FIG. 1.

In FIG. 3, the client 103 (104) or the server 102 is shown as a computer 300.

The computer 300 is provided with a CPU 301 for executing software stored in a ROM 302 or an HDD 311. The CPU 301 controls the overall operation of the computer 300.

A RAM 303 functions as a main memory and a work area or the like of the CPU 301. A keyboard controller (KBD C) 305 controls instruction inputs from a keyboard (KBD) 309.

A display controller (DISP C) 306 controls visual display on a display module (DISPLAY) 310 implemented e.g. by a liquid crystal display or a CRT. A disk controller (DKC) 307 controls the hard disk (HDD) 311 as a large-capacity storage device. A network interface card (NIC) 308 bidirectionally transmits, i.e. sends and receives data to and from external equipment via the network 101 such as a LAN.

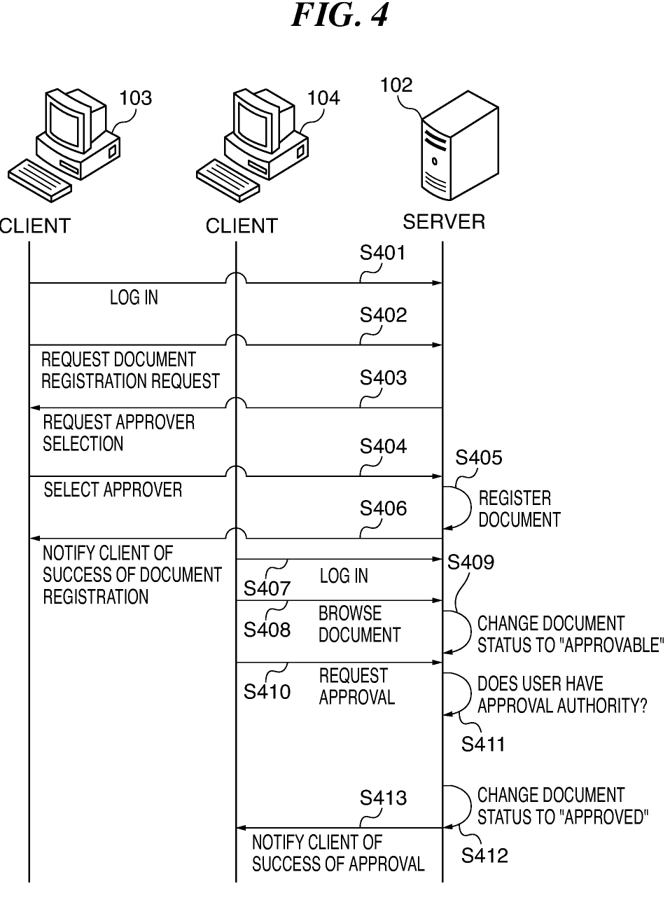

FIG. 4 is a diagram useful in explaining a workflow process carried out using the electronic approval system in FIG. 1.

FIG. 4 shows an example of a workflow in which a user using the client 103 carries out an operation for registering document data in the server 102, and a user using the client 104 carries out an operation for approval of the document data. However, the workflow executable by the present system is not limited to this example, but it may be a workflow other than this. Any data processable by an image forming apparatus, such as image data and document data, can be document data for registration.

The client 103 responsive to an operation by the user using the client 103 transmits user information 701, described hereinafter with reference to FIG. 7, to the server 102, to thereby log in to the server (S401). In the illustrated example, an account of the user using the client 103 is set as a user account 702 of the user information 701. Next, the user selects a document to be registered for workflow processing. Then, the client 103 issues a document registration request for registering the document selected by the user to the server 102 (S402). Upon reception of the document registration request, the server 102 issues an approver selection request to the client 103 (S403).

The client 103 sends user information indicative of a user or users who is/are to approve the document to the server 102 based on an operation by the user using the client 103 (S404). It should be noted that the user or users who is/are to approve the document, i.e. the approvers(s) may be registered in the server 102 in advance. In this case, processing in the step S404 can be omitted. Upon reception of the user information indicative of the approver(s), the server 102 generates document management information 500 from the user information 701 on the user having logged in. The server 102 generates the document management information 500 in which the user information 701 on the user having logged in the step S401 is set as creator information 502, the user information on the user selected as the approver is set as approver information 503, and document status 501 is set to “unapprovable”. Then, the server 102 stores the registered document in association with the document management information 500 (S405). When the registration of the document is normally completed in the step S405, the server 102 sends information indicative of success of the document registration to the client 103 (S406). The document management information 500 will be described in detail hereinafter.

Next, the user having approval authority operates the client 104, and the client 104 transmits the user information 701 to the server 102 to thereby log in to the server 102 (S407). At this time, an account of the user operating the client 103 is set as the user account 702 of the user information 701. When the document registered in the step S405 (hereinafter referred to as the registered document) is accessed and browsed by the client 104 (S408), the server 102 changes the document status 501 in the document management information 500 associated with the registered document to “approvable” (S409).

Upon reception of a request for approval of the registered document (approval request) from the client 104 (S410), the server 102 performs a comparison between the user information 701 on the user operating the client 104 and the approver information 503 associated with the registered document (S411). If the user information 701 matches the approver information 503, the server 102 changes the document status 501 to “approved”, which means completion of approval (S412), and notifies the client 104 as an approval requesting side of success of the approval (S413).

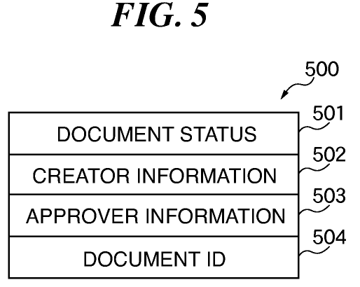

FIG. 5 is a diagram showing an example of the document management information stored in the server in FIG. 3 on a document-by-document basis. The document management information 500 contains the items 501 to 503 and an item 504.

The document status 501 indicates a current status of a document. Statuses indicated by the document status 501 include “being generated”, “unapprovable”, “approvable”, and “approved”, for example. “Being generated” indicates that the document is being generated. “Unapprovable” and “approvable” both indicate that the document has not been approved yet. “Unapprovable” indicates that an approver has not approved the document yet, or has not examined the same correctly.

In the present embodiment, the term “examination” indicates approver's operation of outputting visually a registered document on the display module 310 of the MFP 105 (106) or the client 103 (104) and visually checking the visually output image.

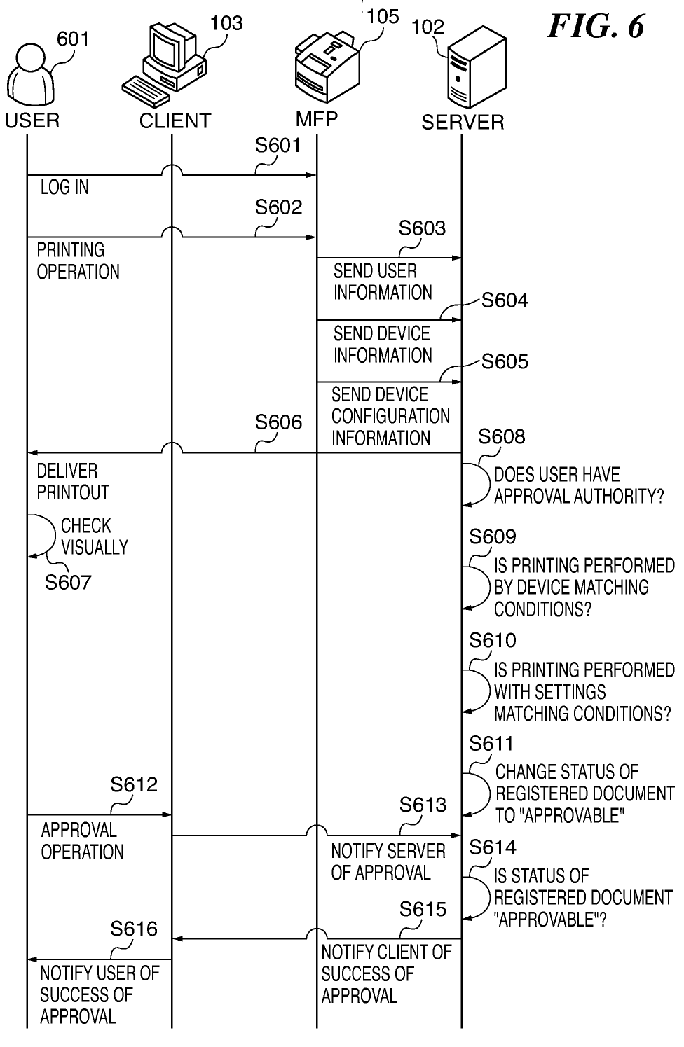

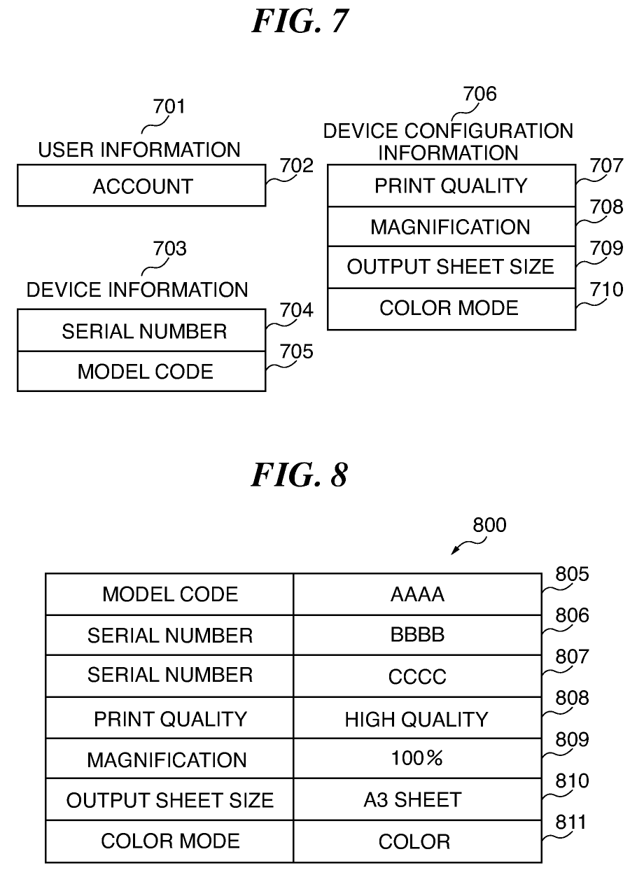

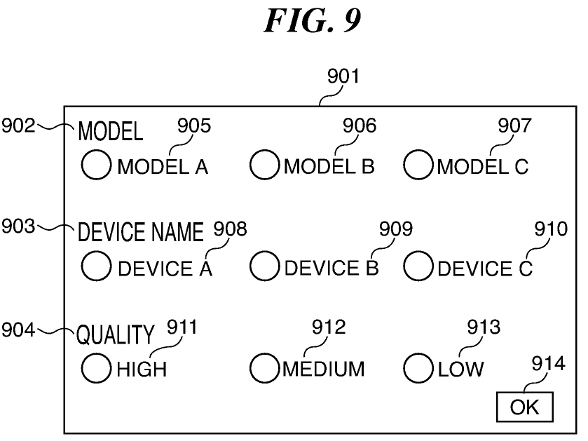

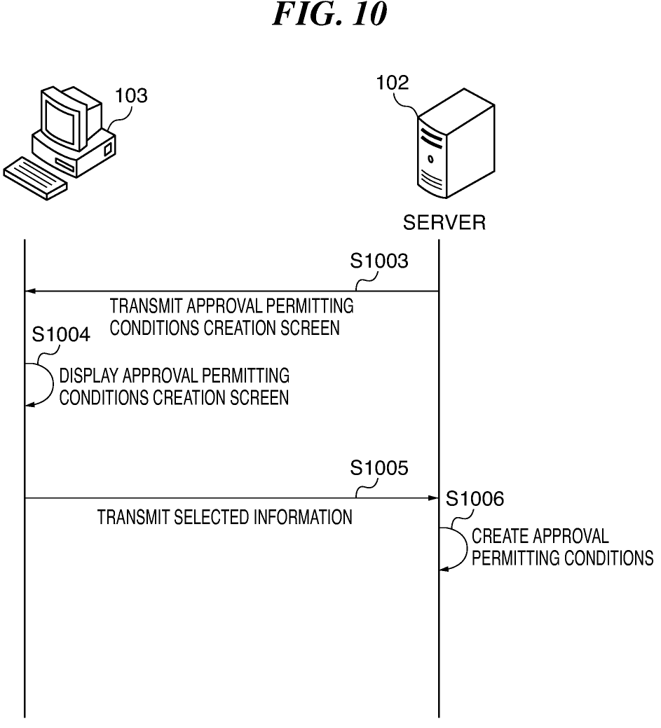

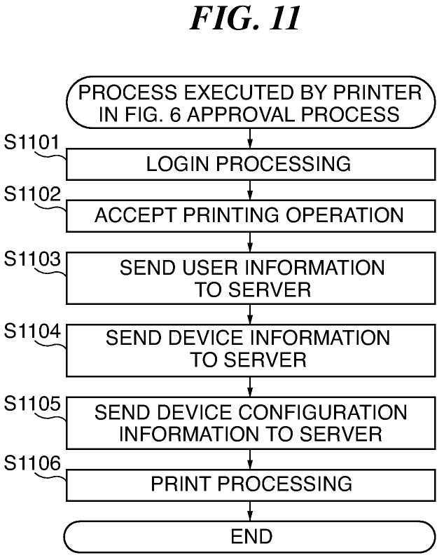

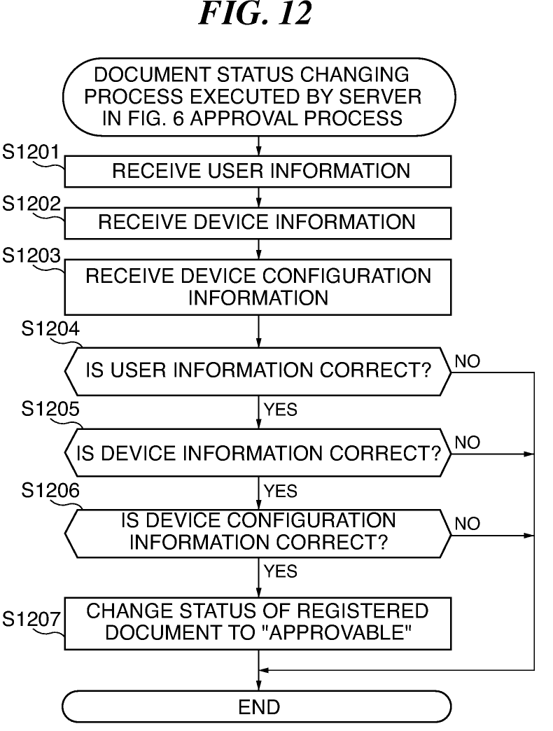

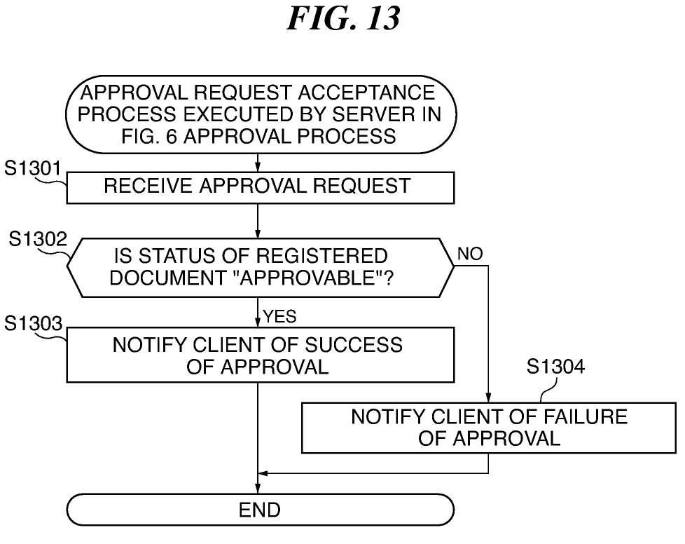

“Approvable” in the document status 501 indicates that the approver has output the document according to correct settings. The term “to output a document” includes to print out the document by the MFP 105 (106) and to display the same on the display module 310. How to determine whether or not settings for outputting a document are correct will be described hereinafter with reference to FIG. 6. “Approved” in the document status 501 indicates that the approver has completed processing for approval of the document.

The creator information 502 indicates the user information 701 on a creator of the document.

The approver information 503 indicates the user information 701 on a user authorized to approve the document. The item, i.e. document ID 504 indicates a document-specific ID. The document ID 504 is used to associate a document with the document management information 500.

FIG. 6 is a diagram useful in explaining an approval process carried out in a case where a user prints a registered document using the MFP in FIG. 2 to check the printed document, and then notifies the server of approval of the document using the client.

A user 601 is in a position to approve a document registered in the server 102. The user 601 carries out an operation for logging in to the MFP 105 (S601). Then, the user 601 carries out an operation for printing the registered document (S602). When the printing operation (S602) is carried out, the MFP 105 transmits the user information 701 on the user 601 who carried out the printing operation, and device information and device configuration information stored in the MFP 105 to the server 102 (S603 to S605).

Thereafter, the MFP 105 acquires the registered document from the server 102 and prints out the same (S606). The user visually checks the printout (S607).

The server 102 stores approval permitting conditions, shown in FIG. 8, on a workflow-by-workflow basis. The approval permitting conditions will be described in detail hereinafter. After receiving the user information sent from the MFP 105 in the step S603, the server 102 performs a comparison to determine whether or not the user information matches the contents of the approver information 503 in the document management information 500 (S608).

Next, after receiving the device information sent from the MFP 105 in the step S604, the server 102 performs a comparison to determine whether or not the device information matches corresponding ones of the approval permitting conditions stored in the server 102 itself (S609). Then, after receiving the device configuration information sent from the MFP 105 in the step S605, the server 102 performs a comparison a comparison to determine whether the device configuration information matches corresponding ones of the approval permitting conditions stored in the server 102 itself (S610).

If the user information, the device information, and the device configuration information match the approval permitting conditions, the document status 501 in the document management information 500 on the registered document is changed to “approvable” (S611).

After checking the printed registered document, the user 601 carries out an approval operation using the client 103 (S612). The client 103 accepts the approval operation and notifies the server 102 that the registered document has been approved (S613).

Upon reception of the notification of the approval of the registered document, the server 102 checks (determines) whether or not a sender of the approval notification matches the user determined in the step S608 as having approval authority, and then checks (determines) whether or not the registered document is approvable by the user (S614). If the registered document is not approvable by the user, the server 102 notifies the client 103 that the registered document is unapprovable.

If the registered document is approvable, the server 102 notifies the client 103 of success of the approval (S615). Upon reception of the approval success notification, the client 103 notifies the user 601 of success of the approval (S616). This completes the approval process for approval of the registered document.

FIG. 7 is a diagram showing in detail examples of the user information, the device information, and the device configuration information.

The user information 701 contains the account 702 assigned on a user-by-user basis. The device information 703 contains an MFP-specific serial number 704 and a model-specific model code 705.

The device configuration information 706 contains print quality 707 indicating whether printing is carried out at a high-quality level or at a standard level, print magnification 708, sheet size 709 indicative of the size of a sheet on which printing is made, and color mode 710 indicating which of color printing and monochrome printing is to be performed. The device configuration information 706 is image output configuration information indicative of settings configured for image output.

Information containing all or at least one of the user information 701, the device information 703, and the device configuration information 706 is referred to as output configuration. The output configuration may contain other information items than the above three.

FIG. 8 is a diagram showing in detail an example of the approval permitting conditions stored in the server on a workflow-by-workflow basis in the approval process in FIG. 6.

Data of the approval permitting conditions 800 is stored in the HDD 311 of the server 102 in association with the registered document and the document management information 500 associated with the registered document. The approval permitting conditions 800 include items 805 to 811.

The model code 805 indicates a model code of an MFP which can perform correct printing for the purpose of approval in the present workflow. Each of serial numbers 806 and 807 indicates the serial number of an MFP which can perform correct printing for the purpose of approval in the present workflow. Although in the FIG. 8 example, both the model code 805 and the serial numbers (806 and 807) are registered in the approval permitting conditions 800, only one of the items may be registered. Further, the approval permitting conditions may contain a plurality of model codes registered as the model code 805. Further, the number of serial numbers registered in the approval permitting conditions 800 may be only one or more than two.

When the model code 705 in the device information 703 sent from the MFP 105 matches the model code 805, the server 102 determines that the device information matches a corresponding one of the approval permitting conditions. Similarly, when the serial number 704 in the device information 703 sent from the MFP 105 matches one of the serial numbers 806 and 807, the server 102 determines that the device information matches a corresponding one of approval permitting conditions.

The print quality 808 indicates a value of print quality determined to be appropriate for correct printing for the purpose of approval in the present workflow. The magnification 809 indicates a value of magnification determined to be appropriate for correct printing for the purpose of approval in the present workflow.

The output sheet size 810 indicates a value of output sheet size determined to be appropriate for correct printing for the purpose of approval in the present workflow. The color mode 811 indicates a value of a color mode determined to be appropriate for correct printing for the purpose of approval in the present workflow.

When the values of the respective items in the device configuration information 706 sent from the MFP 105 match those of the print quality 808, the magnification 809, the output sheet size 810, and the color mode 811, respectively, the server 102 determines that the device configuration information matches respective corresponding ones of the approval permitting conditions.

FIG. 9 is a view of an example of a creation screen for creating the approval permitting conditions in FIG. 8.

The approval permitting conditions creation screen 901 is displayed on the display module 310 based on an application program executed in the client 103 so as to process a workflow.

The user can create approval permitting conditions using the approval permitting conditions creation screen 901 on the client 103 when the document registration request is issued (S402 in FIG. 4). The user can use the approval permitting conditions creation screen 901 to select a value of each item of Model 902, Device Name 903, and Quality 904. The user selects one of models A to C (905 to 907) from Model 902. The Model 902 is for identifying the model of the MFP 105 or 106, an MFP, not shown, or a printer, not shown, and corresponds to the model name of an MFP, for example. The Device Name 903 is for identifying one of the MFPs 105 and 106, MFPS, not shown, or printers, not shown.

The user selects one of device names A to C (908 to 910) from Device Name 903. Further, the user selects one of qualities high to low (911 to 913) from Quality 904. After completing the selection for each of the items 902 to 904, the user presses an OK button 914.

FIG. 10 is a diagram useful in explaining a process carried out for crating the approval permitting conditions in FIG. 8. The process in FIG. 10 is added to the workflow process in FIG. 4. In the present embodiment, the process in FIG. 10 is carried out between the steps S402 and S403 in the workflow process in FIG. 4.

The server 102 sends the approval permitting conditions creation screen 901 to the client 103 (S1003). It should be noted that the approval permitting conditions creation screen 901 may be generated by the client 103.

Next, the client 103 displays the approval permitting conditions creation screen 901 (S1004) to accept operation inputs from the user. Then, when the OK button 914 is pressed, the client 103 sends selected information to the server 102 (S1005).

Upon reception of the selected information, the server 102 creates the approval permitting conditions and stores the same together with the document. The server 102 stores the model names (905 to 907) and the model codes 705 of the respective models in advance, and hence generates the model code 805 in the approval permitting conditions based on the selected model name.

The server 102 stores the device names (908 to 910) and the serial numbers 704 of the respective devices in advance, and hence generates the serial number 806 or 807 in the approval permitting conditions based on the selected model name.

The server 102 stores the device configuration information, i.e. the print quality 707, the magnification 708, the output sheet size 709, and the color mode 710, which is associated with a corresponding one of the qualities (911 to 913) in advance. The server 102 generates the print quality 808, the magnification 809, the output sheet size 810, and the color mode 811 based on the selected one of the qualities 911 to 913. It should be noted that an entry for enabling selection of a color mode may be added to the approval permitting conditions creation screen 901.

In this case, when the user selects “color” or “monochrome” on the screen, the result of the selection is reflected in the color mode 811 in the approval permitting conditions 800.

The data of the approval permitting conditions 800 is stored in the HDD 311 in the server 102 in association with the document registered in the step S405 and the document management information 500.

FIG. 11 is a flowchart of a process carried out by the MFP in the approval process in FIG. 6.

Specifically, the present process is executed by the CPU 201 of the MFP 105 in a case where a document is printed for the purpose of approval.

The MFP 105 accepts the user information 701 from the operating section 220 and performs login processing (S1101). Then, the MFP 105 accepts an operation for printing the registered document from the operating section 220 (S1102). Then, the MFP 105 sends the user information 701 on the user having logged in to the server 102 via the network interface 206 (S1103).

Next, the MFP 105 sends the device information 703 on itself to the server 102 via the network interface 206 (S1104). Then, the MFP 105 sends the device configuration information 706 on the MFP 105 itself to the server 102 via the network interface 206 (S1105). Finally, the MFP 105 acquires the registered document from the server 102 and prints the same (S1106), followed by terminating the present process.

It should be noted that the steps S1103 to S1105 may be executed as a single step. That is, the MFP 105 may collectively send the user information 701, the device information 703, and the device configuration information 706 to the server 102.

The steps S1103 to S1105 implement the details of processing by a transmission unit of the present invention. When a user prints electronic information for examination by an approver, the transmission unit transmits the user information 701 on the user having performed the printing and the device information 703 and the device configuration information 706 on the MFP 105 used for the printing to the server 102 managing the electronic information.

FIG. 12 is a flowchart of a document status changing process carried out by the server in the approval process in FIG. 6.

Specifically, the present process is executed by the CPU 301 of the server 102 when the server 102 receives the user information 701, the device information 703, and the device configuration information 706, so as to change the status of the document.

The server 102 receives the user information 701 from the MFP 105 via the network interface 206 (S1201). Then, the server 102 receives the device information 703 from the MFP 105 via the network interface 206 (S1202). Then, the server 102 receives the device configuration information 706 from the MFP 105 via the network interface 206 (S1203).

Next, the server 102 performs a comparison to determine whether or not the received user information 701 matches the approver information 503 (S1204). If the received user information 701 matches the approver information 503, the process proceeds to a step S1205, whereas if not, the process is terminated.

In the step S1205, the server performs a comparison to determine whether or not the received device information 703 matches the serial number 806 or 807 and the model code 805. If the received device information 703 matches the serial number 806 or 807 and the model code 805, the process proceeds to a step S1206, whereas if not, the process is terminated.

In the step S1206, the server 102 performs a comparison to determine whether or not the received device configuration information 706 matches the print quality 808, the magnification 809, the output sheet size 810, and the color mode 811. If the received device configuration information 706 matches the print quality 808, the magnification 809, the output sheet size 810, and the color mode 811, the process proceeds to a step S1207, whereas if not, the process is terminated.

In the step S1207, the server 102 determines whether or not the document status 501 of the document for approval is “unapprovable”. If the document status 501 is “unapprovable”, the server 102 changes the document status 501 to “approvable”, followed by terminating the present process.

The execution of the present process makes it possible to change the document status 501 of a registered document to “approvable” only when the registered document is printed out based on conditions that match the approval permitting conditions 800. On the other hand, when the registered document is printed out based on conditions that do not match the approval permitting conditions 800, the document status 501 of the registered document remains “unapprovable”. In short, only when the registered document is printed out based on proper conditions, the approver is allowed to approve the registered document.

FIG. 13 is a flowchart of an approval request acceptance process carried out by the server in the approval process in FIG. 6.

Specifically, the present process is executed by the CPU 301 of the server 102 when the server 102 accepts an approval request.

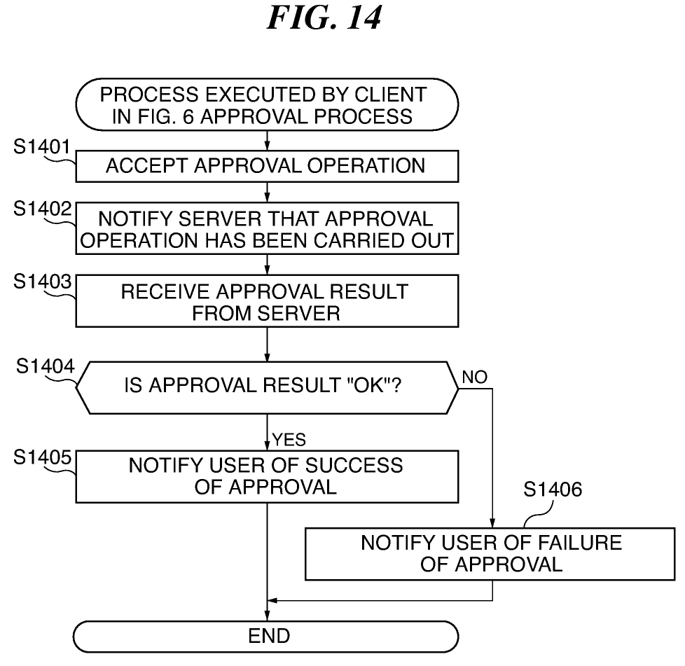

When an approval request is transmitted from the client 103 in a step S1402 of a flowchart described in detail hereinafter with reference to FIG. 14, the server 102 receives the approval request from the client 103 via the network interface 206 (S1301) (corresponding to the details of processing executed by an acceptance unit of the present invention for accepting an approval request from outside the server 102). Then, the server 102 determines whether or not the document status of the document for approval is ‘approvable’ (S1302).

If the document status is “approvable”, the server 102 carries out the approval process for the registered document and notifies the client 103 of success of the approval (S1303). When the approval process is executed for the registered document in the step S1303, the document status 501 of the document management information 500 associated with the document is changed from “approvable” to “approved”.

If the document status is not “approvable”, the server 102 notifies the client 103 of failure of the approval (S1304), followed by terminating the present process.

FIG. 14 is a flowchart of a process carried out by the client in the approval process in FIG. 6.

Specifically, the present process is executed by the CPU 301 of the client 103 when the client 103 accepts an approval operation.

The client 103 accepts an approval operation from the user (S1401) and notifies the server 102, via the network 101, that the approval operation was carried out, i.e. the client 103 issues an approval request to the server 102 (S1402).

When the step S1303 or S1304 of the FIG. 13 process is executed by the server 102, an approval result is transmitted from the server 102. Upon reception of the approval result from the server 102 (S1403), the client 103 determines whether or not the approval result is “success” or “failure” (S1404). If the approval result is “success”, the client 103 notifies the user of success of the approval via the display module 310 (S1405). If the approval result is ‘failure’, the client 103 notifies the user of failure of the approval via the display module 310 (S1406). As a method of notification in the steps S1405 and S1406, it can be envisaged to display an approval result on the display module 310. Alternatively, voice may be used for notification.

The step S1302 in FIG. 13 implements the details of processing executed by a determination unit for determining, when approval is select by the selection unit, whether or not the electronic information is approvable.

As described above, according to the present embodiment, when an approver prints out a registered document for the purpose of approval based on conditions that do not match the approval permitting conditions, subsequent approval of the document is handled as invalid. This makes it possible to handle examination and approval processing as invalid when the processing is executed following an incorrect procedure, to thereby improve the reliability of approval in the workflow.

A system according to a second embodiment is identical in configuration to the system according to the first embodiment. A server, a client, and an MFP are also identical in configuration to those in the first embodiment. Therefore, duplicate description of components corresponding to those in the first embodiment is omitted by denoting them using the same reference numerals, and only different points from the first embodiment will be described.

In the first embodiment, when the user 601 prints electronic information for the purpose of approval, the MFP 105 sends the user information 701, the device information 703, and the device configuration information 706 to the server 102, whereafter the user carries out an approval operation using the client 103.

However, the user may add an approval seal to a printout produced by printing electronic information for the purpose of approval and then carry out an approval operation by scanning the printout using an image forming apparatus. That is, in the second embodiment, an MFP operates as an approval requesting side.

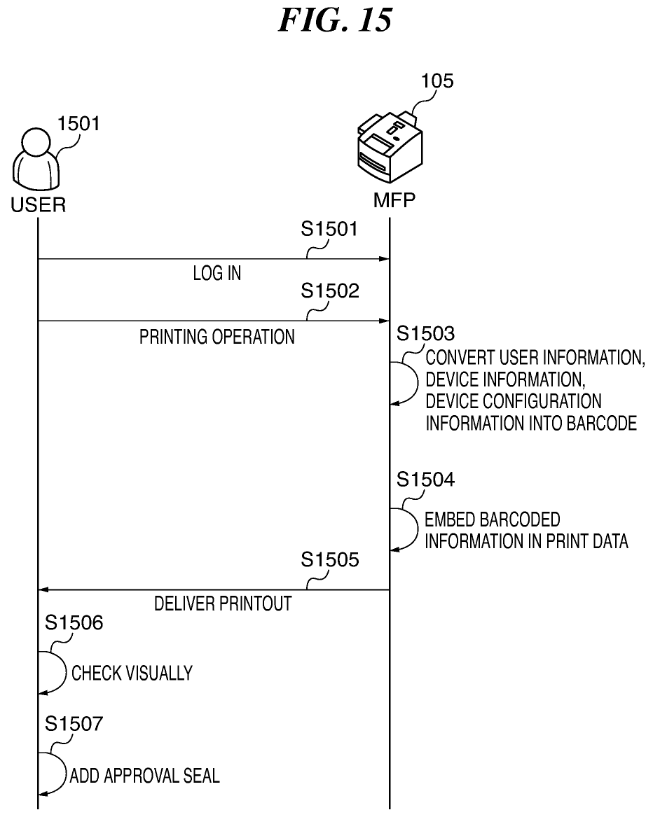

FIG. 15 is a diagram useful in explaining an embedding process carried out by an electronic approval system (workflow system) according to the second embodiment of the present invention in a case where the MFP in FIG. 2 embeds user information, device information, and device configuration information in a registered document printed by a user.

The user 1501 carries out an operation for logging in to the MFP 105 (S1501) and then an operation for printing a registered document (S1502). When the printing operation is performed by the user 1501 (S1502), the MFP 105 converts the user information 701 of the user having carried out the printing operation (S1502), and the device information 703 and the device configuration information 706 stored in the MFP 105 into a barcode (S1503).

When the user information 701, the device information 703, and the device configuration information 706 are converted into a barcode, the MFP 105 embeds (or adds) the barcoded information into print data (S1504). Thereafter, the MFP 105 outputs a printout (S1505). The user 1501 checks the printout (S1506), and adds an approval seal to the printout in the case of approving the printout (S1507).

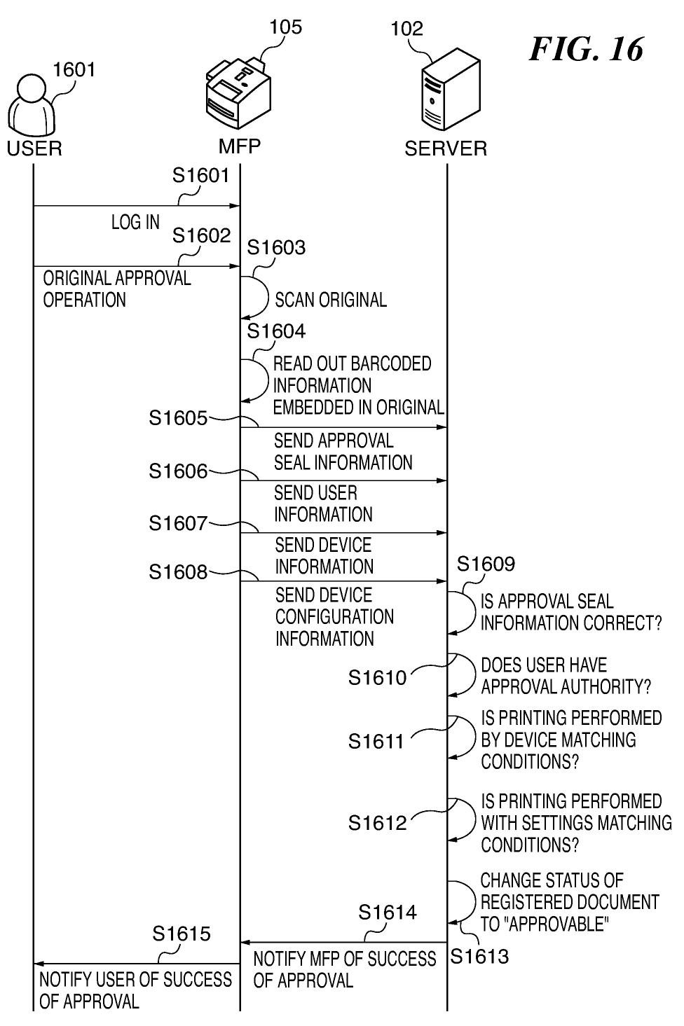

FIG. 16 is a diagram useful in explaining an approval process carried out in a case where a user prints out a registered document using an MFP for use in approval to check the printed document, and then notifies the server of approval of the document using the MFP.

The user 1601 carries out an operation for logging in to the MFP 105 for use in approval (S1601) and then an operation for approving a registered document (S1602).

When the approval operation is performed (S1602), the MFP 105 for use in approval scans an original (S1603). The original scanned in the step S1603 is a printout produced by the approver adding an approval seal to the printout having the barcode embedded therein and output by the MFP 105 by the FIG. 15 process. The MFP 105 for use in approval scans the original and reads out the barcoded information embedded in the same (S1604).

Next, the MFP 105 for use in approval sends approval seal information added to the registered document, and user information 701, device information 703, and device configuration information 706 read out from the barcoded information to the server 102 (S1605 to S1608).

The server 102 stores approval permitting conditions associated with approval seal information, user information 701, device information 703, and device configuration information 706 on a workflow-by-workflow basis. After receiving the approval seal information sent from the MFP 105 for use in approval in the step S1605, the server 102 performs a comparison to determine whether or not the approval seal information matches a corresponding one of the approval permitting conditions stored in the server 102 itself (S1609).

Then, after receiving the user information 701 sent from the MFP 105 for use in approval in the step S1606, the server 102 performs a comparison to determine whether or not the user information 701 matches a corresponding one of the approval permitting conditions stored in the server 102 itself (S1610). Then, after receiving the device information 703 sent from the MFP 105 for use in approval in the step S1607, the server 102 performs a comparison to determine whether or not the device information 703 matches corresponding ones of the approval permitting conditions stored in the server 102 itself (S1611).

Next, after receiving the device configuration information 706 sent from the MFP 105 for use in approval in the step S1608, the server 102 performs a comparison to determine whether or not the device configuration information 706 matches corresponding ones of the approval permitting conditions stored in the server 102 itself (S1612).

If the approval seal information, the user information, the device information, and the device configuration information all match the approval permitting conditions, the server 102 changes the status of the registered document to “approved” (S1613) and notifies the MFP 105 for use in approval of success of the approval (S1614). Upon reception of the approval success notification, the MFP 105 for use in approval notifies the user 1601 of success of the approval (S1615).

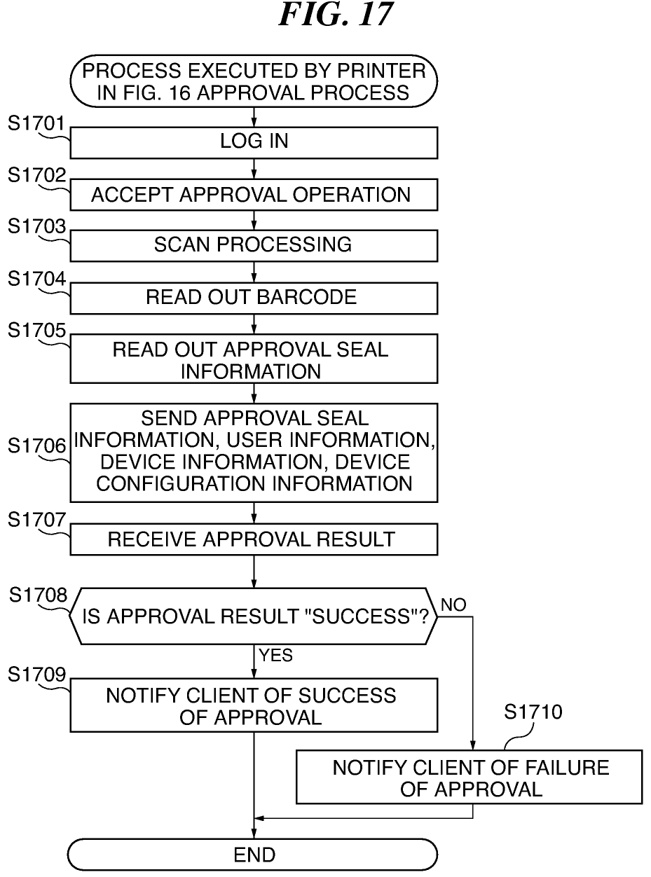

FIG. 17 is a flowchart of a process carried out by the MFP in the approval process in FIG. 16.

The MFP (for use in approval) 105 accepts the user information 701 via the operating section 220 and carries out login processing (S1701). Then, the MFP 105 accepts the approval operation via the operating section 220 (S1702).

Next, the MFP 105 scans the document for approval using the scanner section 221 (S1703). Then, the MFP 105 reads the barcoded information added to the document (S1704).

Next, the MFP 105 reads the approval seal information added to the document (S1705). Then, the MFP 105 sends the user information 701 on the user having logged in, the approval seal information, and the device information 703 and the device configuration information 706 extracted from the read barcoded information to the server 102 via the network interface 206 (S1706).

Next, the MFP 105 receives an approval result sent from the server 102 in response to transmission of the information in the step S1706 (S1707). Upon reception of the approval result, the MFP 105 makes a determination as to the approval result (S1708). If the approval result is “success”, the MFP 105 notifies the client 103 of success of the approval (S1709), followed by terminating the present process. On the other hand, if the approval result is “failure”, the MFP 105 notifies the client 103 of failure of the approval (S1710), followed by terminating the present process.

The step S1704 implements the details of processing executed by a reading unit of the present invention for reading print configuration information embedded in a printout by the embedding unit of the present invention.

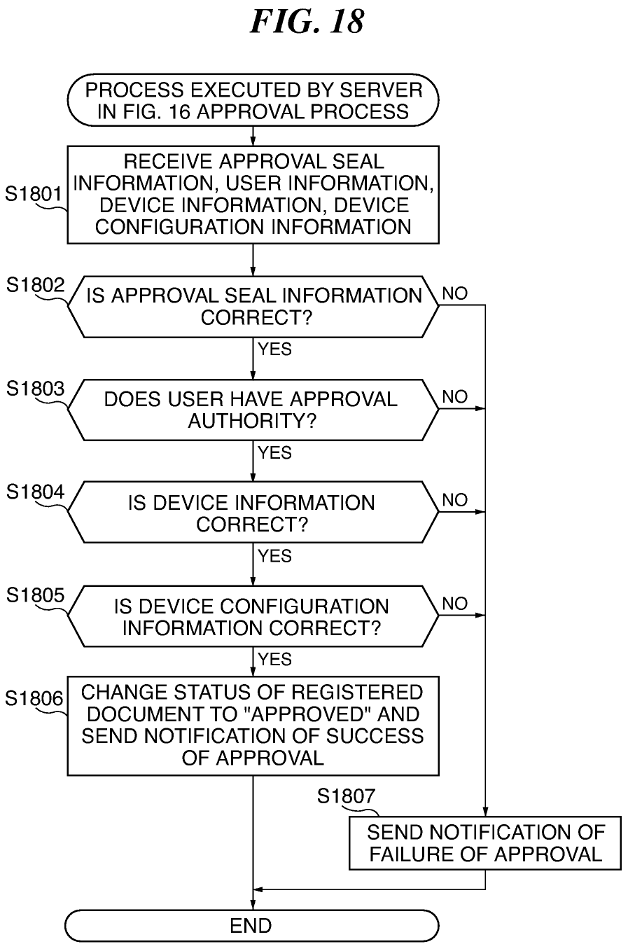

FIG. 18 is a flowchart of a process carried out by the server in the approval process in FIG. 16.

The server 102 receives the user information 701, the approval seal information, and the device information 703 and the device configuration information 706 extracted from the read barcoded information from the MFP 105 via the network interface 206 (S1801). These information items are transmitted from the MFP 105 when the step S1706 in FIG. 17 is executed by the MFP 105.

Next, the server 102 performs a comparison to determine whether or not the approval seal information matches a corresponding one of the approval permitting conditions (S1802). If the approval seal information matches the corresponding one of the approval permitting conditions, the process proceeds to a step S1803, whereas if not, the process proceeds to a step S1807. In the step S1803, the server 102 determines whether or not the user has approval authority. If the user has approval authority, the process proceeds to a step S1804, whereas if not, the process proceeds to the step S1807.

In the step S1804, the server 102 performs a comparison to determine whether or not the received device information 703 matches the serial number 806 or 807 and the model code 805. If the received device information 703 matches the serial number 806 or 807 and the model code 805, the process proceeds to a step S1805, whereas if not, the process proceeds to the step S1807.

Next, the server 102 performs a comparison to determine whether or not the received device configuration information 706 matches the print quality 808, the magnification 809, the output sheet size 810, and the color mode 811 (S1805). If the received device configuration information 706 matches the print quality 808, the magnification 809, the output sheet size 810, and the color mode 811, the process proceeds to a step S1806, whereas if not, the process proceeds to the step S1807.

In the step S1806, the server 102 changes the document status 501 of the document management information 500 associated with the registered document to “approved”, and notifies the MFP 105 of success of the approval, followed by terminating the process shown in FIG. 18 flowchart.

In the step S1807, the server 102 notifies the MFP 105 of failure of the approval, followed by terminating the process shown in FIG. 18 flowchart.

As described above, according to the second embodiment, it is possible to improve the reliability of approval in the workflow similarly to the first embodiment. Further, since the approval processing can be performed using an MFP having printed out a registered document, an approver is freed from the trouble of moving to a client for approval processing, which makes it possible to carry out approval processing more effectively.

A system according to a third embodiment is identical in configuration to the system according to the first embodiment. A server 102, a client 103, and an MFP 105 are also identical in configuration to those in the first embodiment. Therefore, duplicate description of components corresponding to those in the first embodiment is omitted by denoting them using the same reference numerals, and only different points from the first embodiment will be described.

In the first embodiment, when the user 601 prints electronic information for approval, the MFP 105 sends the user information 701, the device information 703, and the device configuration information 706 to the server 102, whereafter the user 601 carries out an approval operation using the client 103.

However, the user 601 may display the electronic information for approval using the client 103 without printing out the same, check the displayed electronic information, and then carry out the approval operation.

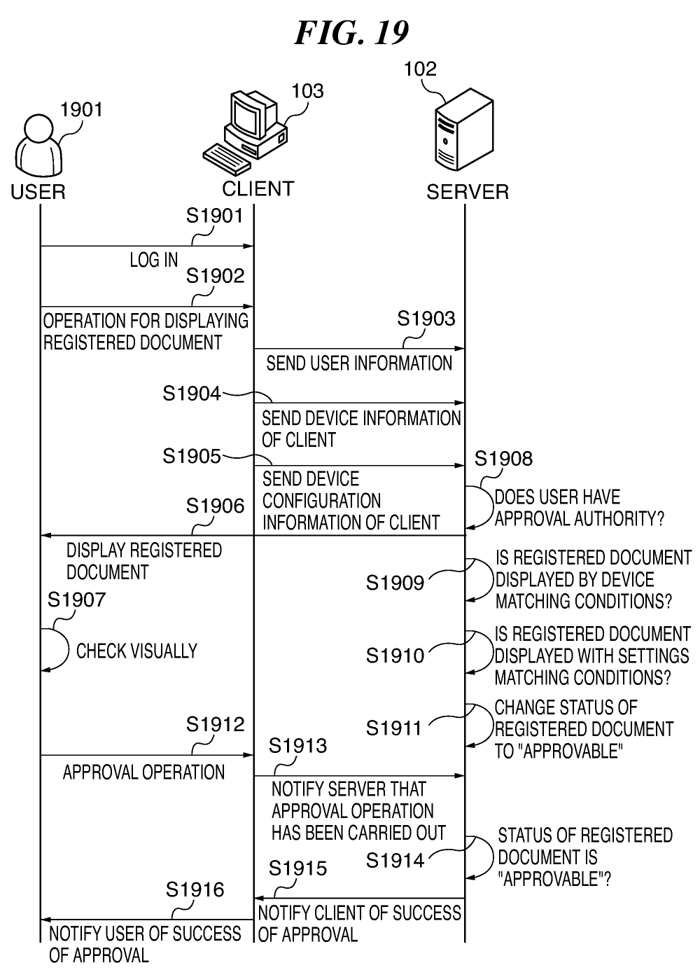

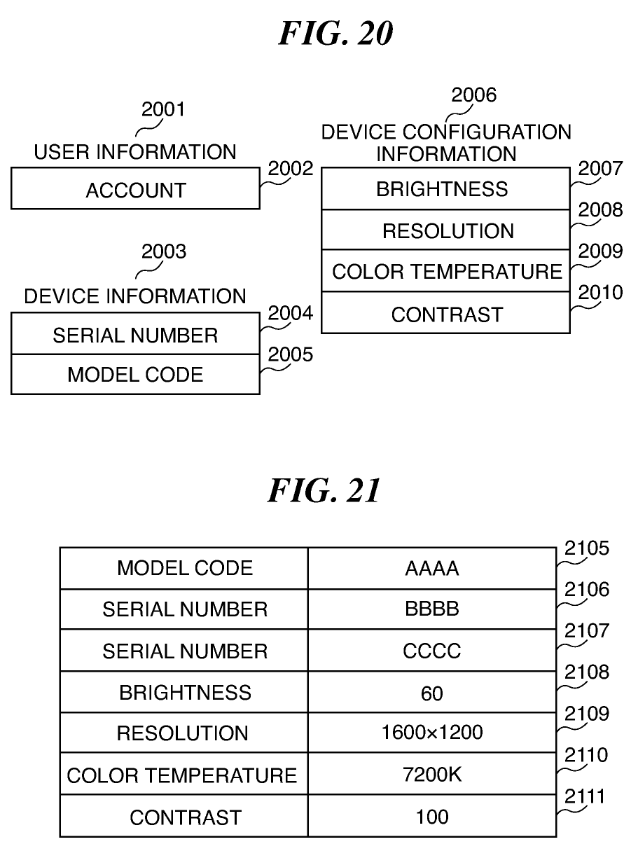

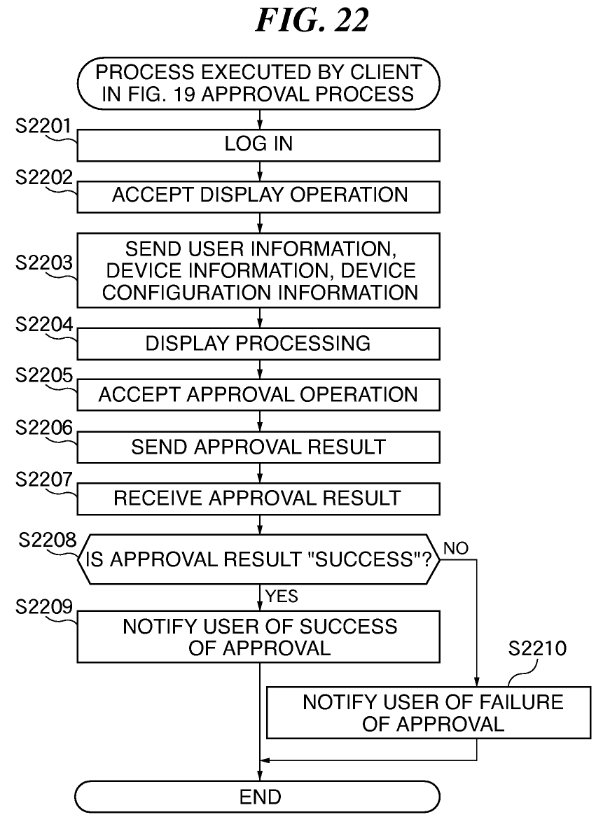

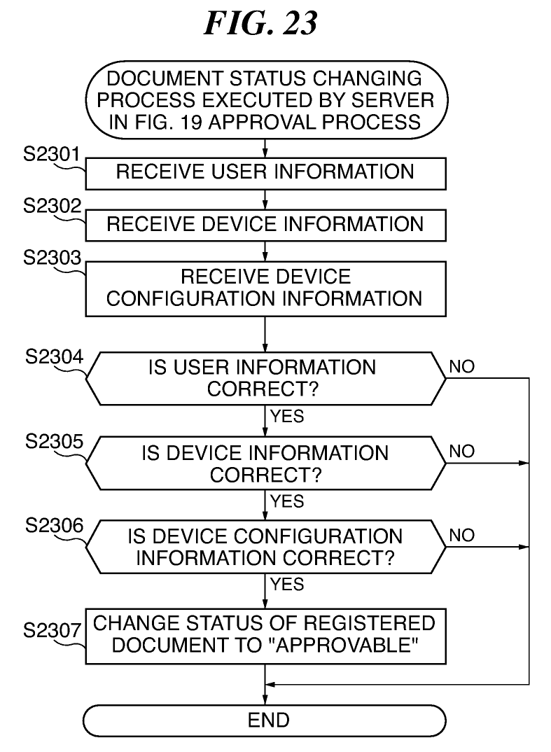

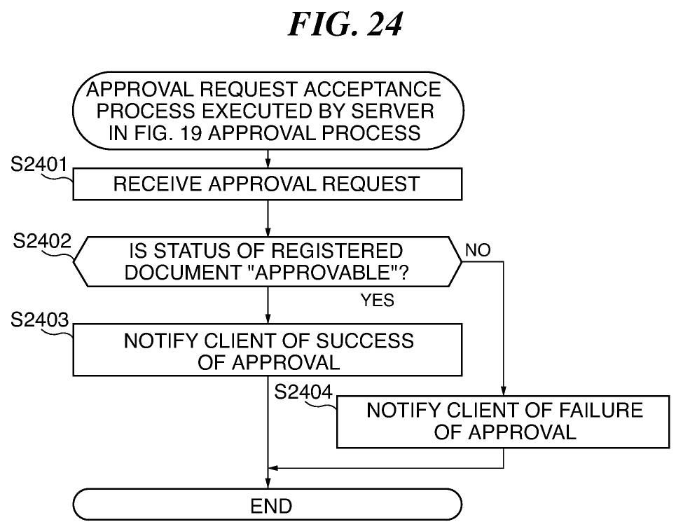

FIG. 19 is a diagram useful in explaining an approval process carried out by the electronic approval system (workflow system) according to the third embodiment in a case where a user displays a registered document using the client in FIG. 3 to check the displayed document, and then notifies the server of approval of the document using the client.

The user 1901 carries out an operation for logging in to the client 103 (S1901) and then an operation for displaying a registered document (S1902). When the display operation (S1902) is carried out, the client 103 sends user information 2001, described hereinafter with reference to FIG. 20, to the server 102 (S1903).

Next, the client 103 sends device information 2003 and device configuration information 2006, described hereinafter with reference to FIG. 20, to the server 102 (S1904 and S1905). Thereafter, the client 103 receives the registered document from the server 102 and displays the same (S1906). The user 1901 visually checks the displayed document (S1907).

The server 102 stores approval permitting conditions associated with the user information 2001, the device information 2003, and the device configuration information 2006 on a workflow-by-workflow basis in advance. After receiving the user information 2001 sent from the client 103 in the step S1903, the server 102 performs a comparison to determine whether or not the user information 2001 matches a corresponding one of the approval permitting conditions stored in the server 102 itself (S1908).

Then, after receiving the device information 2003 sent from the client 103 in the step S1904, the server 102 performs a comparison to determine whether or not the device information 2003 matches corresponding ones of the approval permitting conditions stored in the server 102 itself (S1909).

Next, after receiving the device configuration information 2006 sent from the client 103 in the step S1905, the server 102 performs a comparison to determine whether or not the device configuration information 2006 matches corresponding ones of the approval permitting conditions stored in the server 102 itself (S1910).

If the user information 2001, the device information 2003, and the device configuration information 2006 all match the approval permitting conditions, the server 102 changes the status of the registered document to “approvable” (S1911).

The user 1901 checks the displayed document, and then carries out an approval operation using the client 103 (S1912). The client 103 accepts the approval operation and notifies the server 102 that the approval operation has been carried out for the registered document (S1913).

Upon reception of the approval notification for the registered document, the server 102 checks whether or not the registered document is approvable (S1914). If the registered document is not approvable, the server 102 changes the status of the registered document to “unapprovable”, and notifies the client 103 that the registered document is unapprovable. Specifically, a screen indicative of failure of the approval is displayed on the display module 310 of the client 103.

If the registered document is approvable, the server 102 changes the status of the registered document to “approved”, and notifies the client 103 of success of the approval (S1915). Upon reception of the approval success notification, the client 103 notifies the user 1901 of success of the approval (S1916). Specifically, a screen indicative of success of the approval is displayed on the display module 310 of the client 103.

FIG. 20 is a diagram showing in detail examples of user information, device information, and device configuration information to be sent to the server from the MFP in the approval process in FIG. 19.

The user information 2001 indicates an account 2002 assigned on a user-by-user basis. The device information 2003 includes a display module-specific serial number 2004 assigned on a display module-by-display module basis, and a model-specific model code 2005 assigned on a model-by-model basis. The device configuration information 2006 includes display brightness 2007, display resolution 2008, display color temperature 2009, and contrast 2010 of the associated display module.

FIG. 21 is a diagram showing in detail an example of the approval permitting conditions stored in the server on a workflow-by-workflow basis in the approval process in FIG. 19.

A model code 2105 indicates the model code of a display module 310 determined to be capable of performing correct display for the purpose of approval in the present workflow. Each of serial numbers 2106 and 2107 indicates the serial number of a display module 310 determined to be capable of performing correct display for the purpose of approval in the present workflow.

When the model code 2005 in the device information 2003 sent from the client 103 matches the model code 2105, the server 102 determines that the device information matches a corresponding one of the approval permitting conditions. Similarly, when the serial number 2004 in the device information 2003 sent from the client 103 matches one of the serial numbers 2106 and 2107, the server 102 determines that the device information matches a corresponding one of the approval permitting conditions.

Brightness 2108 indicates the value of brightness determined to be capable of performing correct display for the purpose of approval in the present workflow. Resolution 2109 indicates the value of magnification determined to be capable of performing correct display for the purpose of approval in the present workflow.

Color temperature 2110 indicates the value of color temperature determined to be capable of performing correct display for the purpose of approval in the present workflow. Contrast 2111 indicates the value of contrast determined to be capable of performing correct display for the purpose of approval in the present workflow.

When the values of the respective items in the device configuration information 2006 sent from the client 103 match those of the brightness 2108, the resolution 2109, the color temperature 2110, and the contrast 2111, respectively, the server 102 determines that the device configuration information 2006 matches corresponding ones of the approval permitting conditions.

FIG. 22 is a flowchart of a process carried out by the client in the approval process in FIG. 19.

The client 103 accepts the login operation from the user 1901 (S2201) and then accepts the display operation (S2202).

Next, the client 103 sends the user information 2001 on the user having logged in, and the device information 2003 and the device configuration information 2006 on the display module 310 to the server 102 via the network interface 206 (S2203).

Next, the client 103 displays the registered document on the display module 310 (S2204). Then, the client 103 accepts the approval operation (S2205). Then, the client 103 sends an approval request to the server 102 via the network interface 206 (S2206).

Next, the client 103 receives an approval result from the server 102 (S2207). Upon reception of the approval result, the client 103 makes a determination as to the approval result (S2208). If the approval result is “success”, the client 103 notifies the user 1901 of success of the approval (S2209), followed by terminating the present process. On the other hand, if the approval result is “failure”, the client 103 notifies the user 1901 of failure of the approval (S2210), followed by terminating the present process.

The step S2203 implements the details of processing by the transmission unit of the present invention. When electronic information displayed for examination by an approver, the transmission unit transmits the user information 2001 on the user, i.e. the approver, having displayed the electronic information to the server 102 managing the electronic information. Further, the transmission unit transmits the device information 2003 and the device configuration information 2006 on an image display apparatus (client 103) used for display to the server 102 managing the electronic information.

FIG. 23 is a flowchart of a document status changing process carried out by the server in the approval process in FIG. 19.

The server 102 receives the user information 2001 from the client 103 via the network interface 206 (S2301). Then, the server 102 receives the device information 2003 from the client 103 via the network interface 206 (S2302).

Next, the server 102 receives the device configuration information 2006 from the client 103 via the network interface 206 (S2303). Then, the server 102 performs a comparison to determine whether or not the received user information 2001 matches the approver information 503 (S2304). If the received user information 2001 matches the approver information 503, the process proceeds to a step S2305, whereas if not, the process is terminated.

In the step S2305, the server 102 performs a comparison to determine whether or not the received device information 2003 matches the serial number 2106 or 2107 and the model code 2105. If the received device information 2003 matches the serial number 2106 or 2107 and the model code 2105, the process proceeds to a step S2306, whereas if not, the process is terminated.

In the step S2306, the server performs a comparison to determine whether or not the received device configuration information 2006 matches the brightness 2108, the resolution 2109, the color temperature 2110, and the contrast 2111. If the received device configuration information 2006 matches the brightness 2108, the resolution 2109, the color temperature 2110, and the contrast 2111, the process proceeds to a step S2307, whereas if not, the process is terminated. In the step S2307, the server 102 determines whether the document status 501 of the document for approval is “approvable” or “unapprovable”. If the document status 501 is “unapprovable”, the server 102 changes the document status 501 to “approvable” (S2307), followed by terminating the present process.

FIG. 24 is a flowchart of an approval request acceptance process carried out by the server in the approval process in FIG. 19.

The server 102 receives the approval request from the client 103 via the network interface 206 (S2401). Then, the server 102 determines whether or not the document status of the document for approval is “approvable” (S2402).

If the document status is “approvable”, the server 102 changes the document status of the registered document to “approved” and notifies the client 103 of success of the approval (S2403), followed by terminating the present process. If the document status is not “approvable”, the server 102 changes the document status of the registered document to “unapprovable” and notifies the client 103 of failure of the approval (S2404), followed by terminating the present process.

The step S2402 in FIG. 24 implements the details of processing executed by the determination unit for determining whether or not the electronic information is approvable.

According to the third embodiment, it is possible to improve the reliability of approval in the workflow similarly to the first and second embodiments. Further, the third embodiment makes it possible to approve a registered document not by printing out the registered document using an MFP, but by displaying the same on the display module of the client.

As described above, the system of the present invention may be operated according to any of the above-described first to third embodiments. Further, the first and second embodiments or the second and third embodiments may be combined, or all the first to third embodiments may be combined.

It is to be understood that the present invention may also be accomplished by supplying a system or an apparatus with a storage medium in which a program code of software, which realizes the functions of any of the above described embodiments, is stored, and causing a computer (or CPU or MPU) of the system or apparatus to read out and execute the program code stored in the storage medium.

In this case, the program code itself read from the storage medium realizes the functions of any of the above described embodiments, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of any of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and function.

This application claims priority from Japanese Patent Application No. 2007-275321 filed Oct. 23, 2007, which is hereby incorporated by reference herein in its entirety.

What is claimed is:

1. A workflow system for executing a workflow including a step of approving data, comprising a server apparatus, and an image output apparatus,
wherein said server apparatus comprises a management unit adapted to manage a status of data to be handled in the workflow,
wherein said image output apparatus comprises an output unit adapted to perform a visual output of the data to be handled in the workflow, and a transmission unit adapted to transmit configuration information containing output configuration for the visual output of the data by said output unit and/or information for identifying said image output apparatus, to said server apparatus, and
wherein said management unit manages approval permitting conditions as information indicative of conditions for making the data approvable, in association with the workflow, and determines whether or not to manage the data as approvable, based on the configuration information transmitted from said transmission unit of said image output apparatus and the approval permitting conditions.

2. The workflow system according to claim 1, wherein the approval permitting conditions contains information for identifying an image output apparatus for performing the visual output of the data, as a condition for making the data approvable, and
wherein said management unit manages the data as approvable, based on a match between the information contained in the approval permitting conditions for identifying the image output apparatus and the information contained in the configuration information transmitted from said transmission unit of said image output apparatus for identifying said image output apparatus that outputted the data.

3. The workflow system according to claim 1, wherein the approval permitting conditions contains information for identifying image output configuration for performing the visual output of the data, as a condition for making the data approvable, and
wherein said management unit manages the data as approvable, based on a match between the image output configuration contained in the approval permitting conditions and the output configuration for the visual output of the data by said output unit, which is contained in the configuration information transmitted from said transmission unit.

4. The workflow system according to claim 1, wherein said server unit further comprises an acceptance unit adapted to accept from outside said server apparatus an approval request for approval of data managed by said management unit, and
wherein said management unit handles the approval request accepted by said acceptance unit, as valid, when the data approval of which is requested by the approval request is approvable, and handles the approval request accepted by said acceptance unit, as invalid, when the data approval of which is requested by the approval request is not approvable.

5. The workflow system according to claim 4, wherein when said management unit handles the approval request is valid, said management unit manages the data associated of which approval is requested by the approval request in an approved state, whereas when said management unit handles the approval request as invalid, said management unit notifies a requesting side of the approval request that the approval request is invalid.

6. The workflow system according to claim 1, wherein said image output apparatus further comprises a reading unit adapted to read an image from an original, and
wherein said output unit adds the configuration information to the data, as an image, and then delivers a printout of the data,
wherein said reading unit reads an image from the printout by said output unit as an original, and extracts the configuration information from the image read from the original, and
wherein said transmission unit transmits the information extracted by said reading unit.

7. The workflow system according to claim 1, wherein said image output apparatus is a client computer,
wherein said output unit is a display for performing a visual display of the data, and
wherein the information for identifying the image output apparatus transmitted by said transmission unit is information for identifying the display.

8. An information processing apparatus for managing a workflow including a step of approving data, comprising:
a management unit adapted to manage a status of data to be handled in the workflow;
a storage unit adapted to store approval permitting conditions as information indicative of conditions for making the data approvable, in association with the workflow;
a reception unit adapted to receive configuration information containing output configuration for a visual output of the data by an external image output apparatus and/or information for identifying the image output apparatus; and
a determination unit adapted to determine whether or not to manage the data as approvable, based on the configuration information received by said reception unit and the approval permitting conditions stored in said storage unit.

9. A data approval method for a workflow system that includes a server apparatus, and an image output apparatus, and carries out a workflow including a step of approving data,
wherein the server apparatus manages a status of data to be handled in the workflow,
wherein the image output apparatus performs a visual output of the data to be handled in the workflow,
wherein the image output apparatus transmits configuration information containing output configuration for the visual output of the data and/or information for identifying the image output apparatus, to the server apparatus, and
wherein the server apparatus manages approval permitting conditions as information indicative of conditions for making the data approvable, in association with the workflow, and determines whether or not to manage the data as approvable, based on the configuration information transmitted from the image output apparatus and the approval permitting conditions.

10. A data approval method for an information processing apparatus for managing a workflow including a step of approving data, comprising:
managing a status of data to be handled in the workflow;
storing in a storage unit approval permitting conditions as information indicative of conditions for making the data approvable, in association with the workflow;
receiving configuration information containing output configuration for a visual output of the data by an external image output apparatus and/or information for identifying the image output apparatus; and
determining whether or not to manage the data as approvable, based on the received configuration information and the approval permitting conditions stored in the storage unit.

11. A storage medium storing a program for causing a computer to execute a data approval method for an information processing apparatus for managing a workflow including a step of approving data,
wherein the data approval method comprises:
managing a status of data to be handled in the workflow;
storing in a storage unit approval permitting conditions as information indicative of conditions for making the data approvable, in association with the workflow;
receiving configuration information containing output configuration for a visual output of the data by an external image output apparatus and/or information for identifying the image output apparatus; and
determining whether or not to manage the data as approvable, based on the received configuration information and the approval permitting conditions stored in the storage unit.
